(19) United States
(12) Patent Application Publication
(10) Pub. No.: US 2008/0256687 A1
(43) Pub. Date: Oct. 23, 2008

(54) HELMET

(76) Inventor: Brycen L. Spencer, Carver, MA (US)

Correspondence Address: LOWRIE, LANDO & ANASTASI, LLP, ONE MAIN STREET, SUITE 1100, CAMBRIDGE, MA, 02142, US

(21) Appl. No.: 12/104,785

(22) Filed: Apr. 17, 2008

Related U.S. Application Data
(60) Provisional application No. 60/913,326, filed on Apr. 23, 2007.

(51) Int. Cl. A42B 3/00; G08B 21/00

(52) U.S. Cl. 2/425; 340/669; 340/686.1; 340/540

(57) ABSTRACT

A helmet includes a shell configured to be worn on a head of a user and a sensor coupled to the shell. The sensor is configured to detect deceleration of the shell below a predetermined threshold rate of deceleration and to generate a signal. The helmet further includes a communication module coupled to the shell and the sensor. The communication module is configured to receive the signal from the sensor when the sensor detects a deceleration of the shell below a predetermined threshold rate of deceleration and to generate a signal to a rescue assistance center after a predetermined time period. Other embodiments and methods are disclosed.

### RELATED APPLICATION

This application claims priority under 35 U.S.C. §119(e) to U.S. Provisional Application No. 60/913,326, entitled “WIRELESS IMPACT GUARDIAN,” filed Apr. 23, 2007, which is hereby incorporated by reference in its entirety for all purposes.

### BACKGROUND OF THE INVENTION

1. Field of the Invention

The present disclosure is generally directed to a specially configured safety helmet, and to its method of use. More particularly, the present disclosure relates to a helmet adapted for use with a sensor subsystem for detecting and reporting the occurrence of an accident and a locator subsystem for locating the geographical position of the helmet in real time, and to the use of these various components.

2. Background of the Invention

Everyday, millions of people engage in a variety of activities that either require or recommend the use of a helmet to protect the user's head from injury. When engaging in these activities, which include, for example, motorcycling, all terrain vehicle (“ATV”) riding, snowmobiling, kayaking, bicycling, skiing, snowboarding, mountain climbing, rock climbing, parachuting, and the like, participants may often venture out alone and come upon terrain that is dangerous and/or remote. In the event that a participant needs assistance, for example, should the person become involved in an accident and sustain injuries and/or become stranded while engaging in one of these activities, the person needs to have some mechanism by which he can alert a response crew.

Although cell phones may be used to alert a response crew, cell phone coverage is oftentimes unreliable even while on the beaten path, and, in remote locations, there is often no service at all. Furthermore, even in low speed crashes, cell phones may not survive the impact, as they often fail to work even after small drops from waist height. Furthermore, where the injured party is unconscious, immobile, and/or otherwise seriously injured, placing a cell phone call and/or communicating with the response crew may be impossible.

Accordingly, what is needed for use by an individual engaged in any of various helmet-wearing activities which could result in physical harm to the individual and/or which could send the individual into a potentially isolated and/or remote area, is a system for detecting a distressed person and for locating the geographical position of the distressed person. Such a system should be small enough such that it can be directly incorporated into a user's helmet, and should be relatively inexpensive such that the purchase of the helmet is not unduly burdensome. Such a system should be employable by any person engaged in an activity of excursion or adventure that requires or recommends the use of a helmet, including, but not limited to, bicycling, motorcycling, kayaking, skiing, snowboarding, jet skiing, mountain climbing, rock climbing, parachuting, and the like.

### BRIEF SUMMARY OF THE INVENTION

The above-discussed drawbacks and deficiencies of the prior art are addressed by a helmet adapted for use with a sensor subsystem and a locator subsystem. The sensor subsystem may detect a traumatic event, such as rapid deceleration, and transmits a signal to response crews that an accident has occurred. The locator subsystem comprises location technology that allows a user's location to be relayed to response crews. The individual components of the sensor subsystem and the locator subsystem, which are physically incorporated into the helmet, are sufficiently small in design such that they can be integrated with the helmet without any interruption to the streamlined design of the helmet.

One aspect of the disclosure is directed to a helmet comprising a shell configured to be worn on a head of a user and a sensor coupled to the shell. The sensor is configured to detect deceleration of the shell below a predetermined threshold rate of deceleration and to generate a signal. The helmet further comprises a communication module coupled to the shell and the sensor. The communication module is configured to receive the signal from the sensor when the sensor detects a deceleration of the shell below a predetermined threshold rate of deceleration and to generate a signal to a rescue assistance center after a predetermined time period.

Embodiments of the helmet may also include a control module coupled to the shell, the sensor and the communication module, the control module being configured to process the signal generated by the sensor. The helmet may further include a power supply coupled to the sensor and the control module. In one embodiment, the power supply is configured to supply power to the control module. The helmet may further include a strap coupled to the shell and the power supply. In a certain embodiment, the strap includes at least one strap portion configured to be secured under the chin of the user. The arrangement is such that the at least one strap portion, when secured, activates the power supply. The control module may further include a notification device. In a certain embodiment, the notification device is configured to generate an audible signal to the user when the sensor detects the deceleration of the shell. The control module may further include a switching device. In one embodiment, the switching device is configured to deactivate the communication module when manipulated by the user. In a particular embodiment, the sensor is an accelerometer configured to generate a signal when detecting a deceleration of the shell below a predetermined threshold rate of deceleration. In another embodiment, the communication module includes a global positioning system and may further be configured to provide a location signal to locate the user. Specifically, the communication module may be configured to provide a location signal to locate the user. The sensor may be configured to generate a signal when the shell is stationary for a predetermined period of time.

Another aspect of the disclosure is directed to a helmet comprising a shell configured to be worn on a head of a user, a control module coupled to the shell, and a strap coupled to the shell and the control module. In one embodiment, the strap may include at least one strap portion configured to be secured under the chin of the user. The arrangement is such that the at least one strap portion, when secured, activates the control module. The helmet further comprises a sensor coupled to the shell and the control module. The sensor is configured to detect an event affecting the shell and to generate a signal. The helmet further includes a communication module coupled to the shell and the control module. The communication module may be configured to receive the signal from the control module when the sensor detects an event.

Embodiments of the helmet may include providing the control module with a notification device that is configured to generate an audible signal to the user when the sensor detects the deceleration of the shell. In one embodiment, the control module may further include a switching device. The switching device may be configured to deactivate the communication module when manipulated by the user. The communication module may be further configured to generate a signal to a rescue assistance center after a predetermined time period. In a certain embodiment, the helmet may further include a power supply coupled to shell and the strap, the power supply being configured to supply power to the control module. The communication module may include a global positioning system and may be further configured to provide a location signal to locate the user.

Yet another aspect of the disclosure is directed to a helmet comprising a shell configured to be worn on a head of a user and a sensor coupled to the shell. The sensor may be configured to detect an event affecting the shell and to generate a signal. The helmet further comprises a control module coupled to the shell and the sensor. The control module may include a notification device configured to generate an audible signal to the user when the sensor detects an event. The helmet further comprises a communication module coupled to the shell and the control module. The communication module is configured to receive the signal from the control module when the sensor detects an event.

Embodiments of the helmet may include providing the control module with a switching device. In a certain embodiment, the switching device may be configured to deactivate the communication module when manipulated by the user. The communication module may be further configured to generate a signal to a rescue assistance center after a predetermined time period. In another embodiment, the helmet may further include a power supply coupled to shell and the control module, the power supply being configured to supply power to the control module.

An additional aspect of the disclosure is directed to a method of detecting an event and transmitting a signal upon detecting the event. In one embodiment, the method comprises: donning a helmet on a head of a user; wearing the helmet during an activity involving movement at a rate of speed; detecting a deceleration of the helmet below a predetermined threshold rate of deceleration; generating a signal upon detecting the deceleration after a predetermined time period; and providing a response to the signal. Embodiments of the method may be directed to, when donning the helmet, fastening at least one strap portion under a chin of the user to activate components of a system capable of detecting the deceleration and generating the signal. The method may further include detecting inactivity of the helmet for a predetermined period of time and generating a signal upon detecting the inactivity, generating an audible signal to the user when detecting the deceleration of the shell, and/or activating a switch to cease the generation of the signal. In a certain embodiment, when providing a response, the position of the user is located.

In another embodiment, the method comprises: donning a helmet on a head of a user by fastening at least one strap portion under a chin of the user to activate components of a system capable of detecting an event; wearing the helmet during an activity involving movement at a rate of speed; detecting an event; generating a signal upon detecting the event; and providing a response to the signal.

In a further embodiment, the method comprises: donning a helmet on a head of a user to activate components of a system capable of detecting an event; wearing the helmet during an activity involving movement at a rate of speed; detecting an event and generating an audible signal to notify the user of the event; generating a signal upon detecting the event if the user does not respond in a predetermined manner; and providing a response to the signal.

The present disclosure will be more fully understood after a review of the following figures, detailed description and claims.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a perspective view of a helmet;

FIG. 2 is a block diagram of a helmet of an embodiment of the disclosure; and

FIGS. 3-5 illustrate methods of embodiments of the disclosure.

### DETAILED DESCRIPTION OF THE INVENTION

For the purposes of illustration only, and not to limit the generality, the disclosure will now be described in detail with reference to the accompanying figures. This disclosure is not limited in its application to the details of construction and the arrangement of components set forth in the following description or illustrated in the drawings. The teachings disclosed herein are capable of other embodiments and of being practiced or being carried out in various ways. Also the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The disclosure is directed to a helmet adapted for use with an accident assistance system. The accident assistance system may comprise a sensor subsystem that detects an event such as an accident, a communication subsystem that communicates an event to a third party, and a location subsystem that precisely locates the geographical position of the user. In one embodiment, the components of the sensor subsystem, the communication subsystem and the locator subsystem are sufficiently compact to fit the physical dimensions of a variety of helmets, including without limitation, for example, bicycle helmets, motorcycle helmets, ski helmets, ATV helmets, parachuter helmets, military helmets, and the like.

In an exemplary embodiment, the sensor subsystem may comprise a plurality of sensors, preferably gravitational sensors, and a sensing diagnostic module (“SDM”), which detects when the user, or, where appropriate, the user's mode of conveyance, has decelerated at a rate beyond a predetermined or preset threshold level. When the user, or the user's mode of conveyance, decelerates, the plurality of sensors transmits information to the SDM. When the SDM detects that the rate of deceleration has surpassed a threshold level, the SDM signals the communication subsystem to send a message to a rescue assistance center.

In addition to receiving information that a person is in distress, the rescue assistance center may be configured to identify the location of the user via the location subsystem, components of which are integrated into the helmet. In an exemplary embodiment, the location subsystem may calculate position via global positioning system (“GPS”) technology. That is, a GPS receiver, which is incorporated in the helmet, picks up signals from GPS satellites and calculates the location of the helmet. This location information may be stored in hardware located in the helmet. As stated above, when the deceleration rate is above the threshold level, the communication subsystem may place an embedded cellular call to the rescue assistance center. The GPS location data calculated by the GPS receiver may be sent at the beginning of the call. In one configuration, the cellular call is received by a cellular tower and routed to the land line phone system. The switch sends the call to an operator at the rescue assistance center who can call up the geographical position of the distressed person via, for example, a computer screen.

Alternatively, in another exemplary embodiment, the locator sub-assembly may utilize personalized location beacon (“PLB”) technology to detect the location of the helmet. With this particular embodiment, the helmet may be fitted with a PLB transmitter. The PLB transmitter sends a coded radio signal to an orbiting satellite. The satellite then re-transmits the signal to a ground station that passes it on to a rescue assistance center. Through the use of relatively sophisticated technology, which is known in the art, it is possible to determine the location of the source of the distress signal. Alternatively, the PLB may be equipped with a GPS chip, in which case, the PLB transmitter itself can transmit location information derived from the GPS. The PLB transmitter can then send this positional information directly to the appropriate search and rescue authority.

In an exemplary method of use, when a user wearing the helmet experiences an event that causes the user to decelerate at a rate that exceeds the predetermined threshold level, as determined by the SDM of the sensor subsystem, the SDM may transmit a signal to the rescue assistance center via the communication subsystem, thereby alerting the center that the user may be in distress. Additionally, either via a GPS tracking subsystem and/or via a PLB-based subsystem, components of which are also integrated into the helmet, positional information is transmitted to the rescue assistance center so that the user's location may be readily identified.

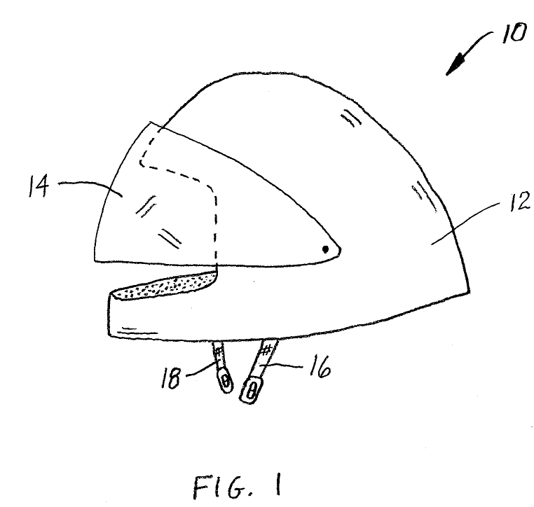

Referring now to the drawings, and more particularly to FIG. 1, a helmet of an embodiment of the disclosure is generally indicated at 10. As shown, the exemplary helmet 10 is a motorcycle helmet. However, as discussed above, the principles disclosed herein may be applicable to other types of helmets, including, but not limited to, ATV helmets, snowmobiling helmets, kayaking helmets, bicycling helmets, skiing helmets, snowboarding helmets, mountain climbing helmets, rock climbing helmets, parachuting helmets, and the like.

Helmet 10 may be of typical construction, including an outer shell 12, padding (not shown) provided within the interior of the shell, a visor 14, and a pair of chin straps 16, 18. The shell 12 and the padding are configured to protect the user when wearing the helmet 10 in the traditional manner. The visor 14 is configured to protect the user's face and to prevent objects from affecting the user's visibility when wearing the helmet 10. As shown, the visor 14 may be hingedly secured to the shell 12 in the well known manner so that the user may raise the visor (as illustrated in FIG. 1) to allow air to vent into the interior of the helmet 10. The chin straps 16, 18 may be secured in the usually manner by any well know fastening device (not designate), such as a pair of snap fasteners. Although two chin straps 16, 18 are shown in FIG. 1, it is understood that only one chin strap may be provided to secure the helmet on the head of the user during use.

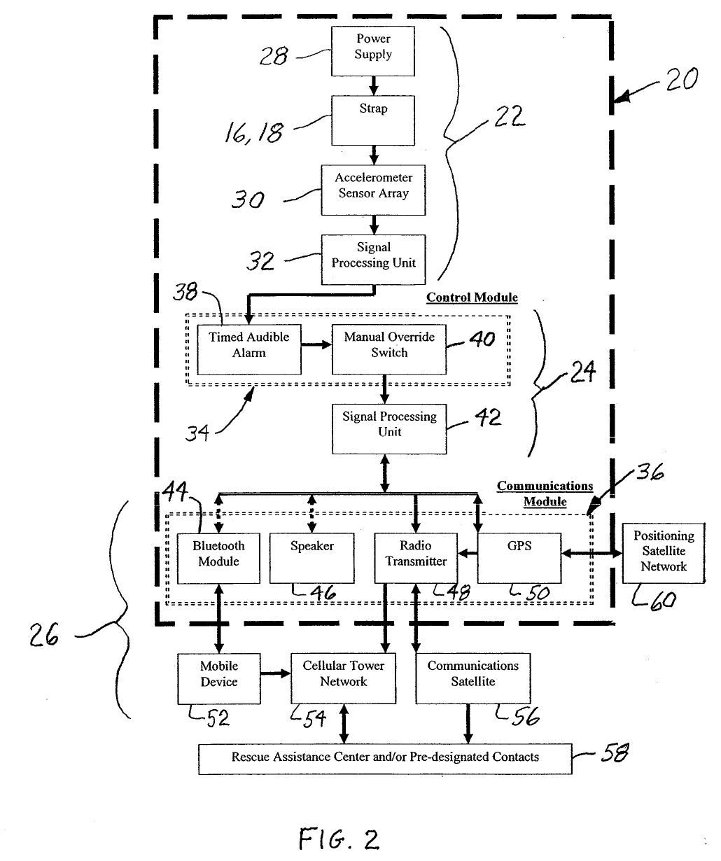

Turning now to FIG. 2, the components of a system designed to detect an event, such as a rapid reduction in speed, and to communicate the event to an emergency responder, is generally indicated at 20. Broadly speaking, the system 20 includes three subsystems, namely, a sensor subsystem 22, a control subsystem 24 and a communication subsystem 26, which may be configured to communicate a distress signal and locate the position of the user of the helmet 10. As shown, the sensor subsystem 22 includes a power supply 28 configured to provide power to the system, a sensor array 30, and a signal processing unit 32. In one embodiment, the power supply 28 is coupled to the components of the system when the chin straps 16, 18 of the helmet are secured under the user's chin. Stated another way, when employing this feature, the system 20 is powered when the user secures the helmet. Thus, the system 20 may be only activated by the user donning the helmet 10 and securing the helmet to the user's head by fastening the chin straps 16, 18 or chin strap as the case may be. The chin straps 16, 18 may be coupled to the sensor, and more particular, a sensor array 30, which, in one embodiment, may include an accelerometer. By way of example, the accelerometer may be a single-axis, high-g iMEMS® accelerometer sold by Analog Devices, Inc. of Norwood, Mass. under model number ADXL193. Other accelerometers may be employed, such as an AN-602 accelerometer, which is also sold by Analog Devices, Inc. of Norwood, Mass. The arrangement is such that when the sensor array detects an event, the sensor array generates a signal to the signal processing unit.

Other types of sensors may be employed rather than the accelerometer. For example, the sensor may include gravitational sensors, force transducers that detect impacts and/or structural damage to the shell of the helmet, strain gauges, movement sensors, optical sensors and other types of sensing devices.

The control subsystem 24 may include a control module, generally indicated at 34, and the communication subsystem 26 may include a communication module, generally indicated at 36. In one embodiment, the control module 34 includes a timed audible alarm 38, which may be configured to generate an audible noise through a speaker upon receiving a signal from the signal processing unit 32 when an event occurs, such as a rapid deceleration of the helmet 10. The control module 34 further may include a manual override switch 40, which is configured to be manually manipulated by the user. For example, there may be instances in which the helmet 10 does not actually experience an event, but generates a false signal of such an event. When this occurs, the user may manually activate the switch 40 to cease the operation of the system 20 in general and the communication subsystem 26 in particular. In another example, there may be instances in which the user, although experiencing an event, does not require the communication of the event to an emergency service provider. Again, when this occurs, the user may manually activate the switch 40 to cease the operation of the system.

When an event occurs, and the user does not override the signal as described above, the control module 34 generates a signal to another signal processing unit 42. It should be understood that the signal processing unit 42 may be the same signal processing unit 32 that signals the control module 34, depending on the configuration of the system 20. The signal processing unit 42 is configured to generate a signal to the communication module 36.

As shown in FIG. 2, the communication module 36 may include a blue tooth module 44, a speaker 46, a radio transmitter 48, and a GPS device 50, the arrangement of which will be discussed herein. Specifically, the blue tooth device 44 may communicate with a mobile device 52, such as a cell phone, to communicate the event to a predetermined person or responder. The speaker 46 may be provided to generate an audible noise to the user when receiving a signal from the timed audible alarm 38 via the signal processing unit 42.

The radio transmitter 48 and the GPS device 50 may provide communication of the event to a third party. In one embodiment, the radio transmitter 48, upon receiving a signal of an event from the signal processing unit 42, may generate a signal to one of either a cellular tower network 54 or a communications satellite 56, or both, to communicate the event to a rescue assistance center and/or a predetermined contact 58, together referred to as an “RAC.” The radio transmitter 48 may be configured to enable communication between the user of the helmet 10 and the RAC while assistance to the user is being sent.

To locate the user, the GPS device 50 may communicate with a positioning satellite network 60 to determine the exact location of the user of the helmet 10. This information may be sent to the RAC 58 by the communication module 36, and the radio transmitter 48, in particular. The arrangement is such that upon the detection of an event, the location and condition of the user of the helmet 10 may be communicated to the RAC 58 for immediate response.

By way of example, the GPS device may include a GEOS-Locator™, which is manufactured by the GEOS Alliance. Another GPS device may include the AXTracker® MMT, which is sold by Axonn, LLC of Covington, La.

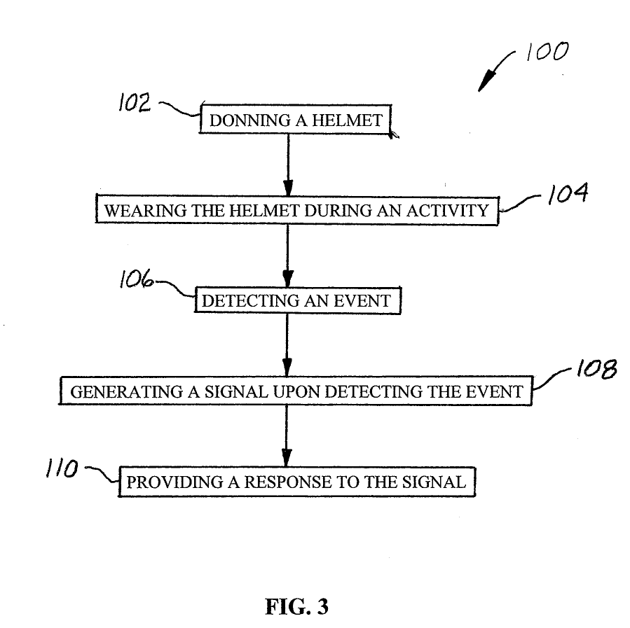

Methods of detecting an event and communicating the event to a third party are further disclosed. In one embodiment, with reference to FIG. 3, a method 100 may comprise: (a) donning a helmet on a head of a user at step 102; (b) wearing the helmet during an activity involving movement at a rate of speed at step 104; (c) detecting a deceleration of the helmet below a predetermined threshold rate of deceleration at step 106; (d) generating a signal upon detecting the deceleration after a predetermined time period at step 108; and (e) providing a response to the signal at step 110. Embodiments of the method shown in FIG. 3 may further include when donning the helmet, fastening at least one strap portion under a chin of the user to activate components of a system capable of detecting the deceleration and generating the signal. In a certain embodiment, the method may further include detecting inactivity of the helmet for a predetermined period of time and generating a signal upon detecting the inactivity. In another embodiment, the method may further include generating an audible signal to the user when detecting the deceleration of the shell. In yet another embodiment, the method may further include activating a switch to cease the generation of the signal. With this embodiment, the switch may be activated manually by the user of the helmet. Another embodiment may include locating a position of the user.

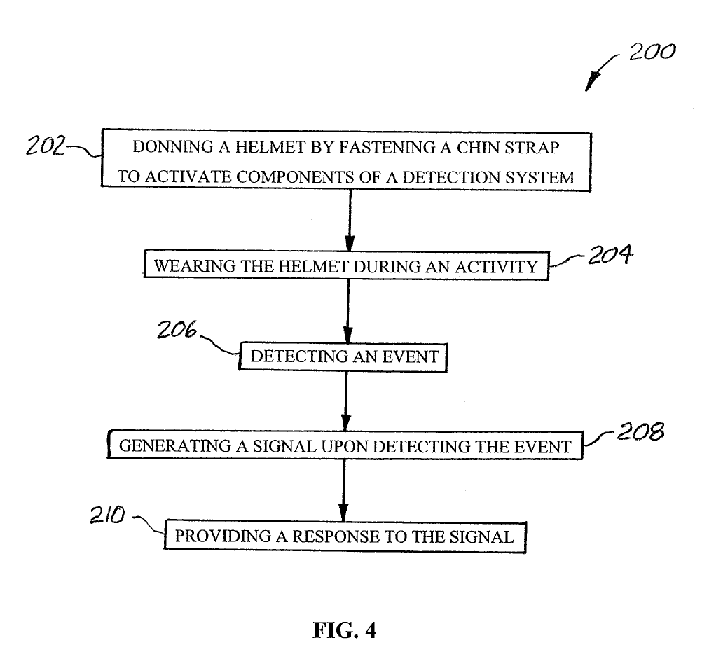

In another embodiment, with reference to FIG. 4, a method 200 may comprise: (a) donning a helmet on a head of a user by fastening at least one strap portion under a chin of the user at step 202 to activate components of a system capable of detecting an event; (b) wearing the helmet during an activity involving movement at a rate of speed at step 204; (c) detecting an event at step 206; (d) generating a signal upon detecting the event at step 208; and (e) providing a response to the signal at step 210.

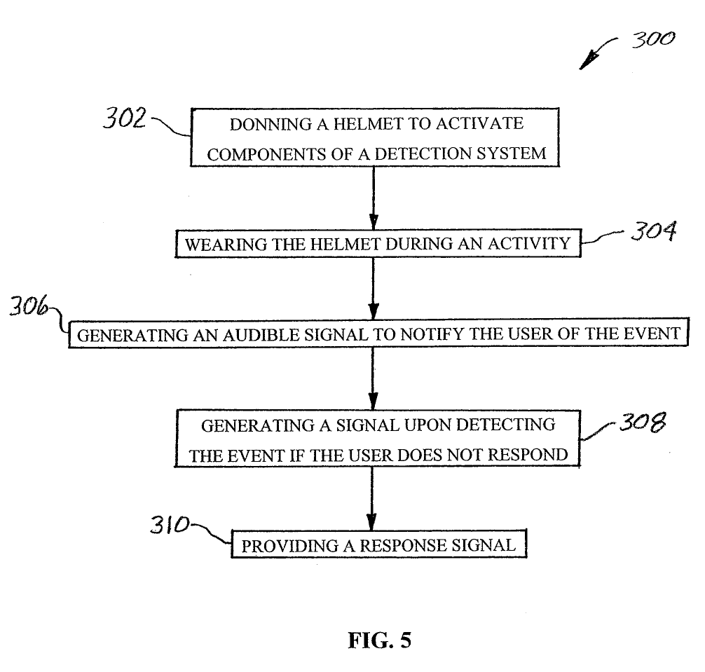

Referring to FIG. 5, another method 300 may comprise: (a) donning a helmet on a head of a user to activate components of a system capable of detecting an event at step 302; (b) wearing the helmet during an activity involving movement at a rate of speed at step 304; (c) detecting an event and generating an audible signal to notify the user of the event at step 306; (d) generating a signal upon detecting the event if the user does not respond in a predetermined manner at step 308; and (e) providing a response to the signal at step 310.

Thus, it should be observed that the helmet described herein includes a system that is capable of detecting a distressed person and of locating the geographical position of the distressed person. The system is small enough such that it can be directly incorporated into a user's helmet, and is relatively inexpensive such that the purchase of the helmet is not unduly burdensome. The system is employable by any person engaged in an activity of excursion or adventure that requires or recommends the use of a helmet, and may be easily worn by the user without any impact to the user's comfort.

Having thus described several aspects of at least one embodiment of this disclosure, it is to be appreciated various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

What is claimed is:

1. A helmet comprising:
a shell configured to be worn on a head of a user;
a sensor coupled to the shell, the sensor being configured to detect deceleration of the shell below a predetermined threshold rate of deceleration and to generate a signal; and
a communication module coupled to the shell and the sensor, the communication module being configured to receive the signal from the sensor when the sensor detects a deceleration of the shell below a predetermined threshold rate of deceleration and to generate a signal to a rescue assistance center after a predetermined time period.

2. The helmet of claim 1, further comprising a control module coupled to the shell, the sensor and the communication module, the control module being configured to process the signal generated by the sensor.

3. The helmet of claim 2, further comprising a power supply coupled to the sensor and the control module, the power supply being configured to supply power to the control module.

4. The helmet of claim 3, further comprising a strap coupled to the shell and the power supply, the strap comprising at least one strap portion configured to be secured under the chin of the user, the arrangement being such that the at least one strap portion, when secured, activates the power supply.

5. The helmet of claim 2, wherein the control module further comprises a notification device, the notification device being configured to generate an audible signal to the user when the sensor detects the deceleration of the shell.

6. The helmet of claim 5, wherein the control module further comprises a switching device, the switching device being configured to deactivate the communication module when manipulated by the user.

7. The helmet of claim 1, wherein the sensor is an accelerometer configured to generate a signal when detecting a deceleration of the shell below a predetermined threshold rate of deceleration.

8. The helmet of claim 1, wherein the communication module includes a global positioning system and is further configured to provide a location signal to locate the user.

9. The helmet of claim 8, wherein the communication module is configured to provide a location signal to locate the user.

10. The helmet of claim 1, wherein the sensor is configured to generate a signal when the shell is stationary for a predetermined period of time.

11. A helmet comprising:
a shell configured to be worn on a head of a user;
a control module coupled to the shell;
a strap coupled to the shell and the control module, the strap comprising at least one strap portion configured to be secured under the chin of the user, the arrangement being such that the at least one strap portion, when secured, activates the control module;
a sensor coupled to the shell and the control module, the sensor being configured to detect an event affecting the shell and to generate a signal; and
a communication module coupled to the shell and the control module, the communication module being configured to receive the signal from the control module when the sensor detects an event.

12. The helmet of claim 11, wherein the control module further comprises a notification device, the notification device being configured to generate an audible signal to the user when the sensor detects the deceleration of the shell.

13. The helmet of claim 12, wherein the control module further comprises a switching device, the switching device being configured to deactivate the communication module when manipulated by the user.

14. The helmet of claim 11, wherein the communication module is further configured to generate a signal to a rescue assistance center after a predetermined time period.

15. The helmet of claim 11, further comprising a power supply coupled to shell and the strap, the power supply being configured to supply power to the control module.

16. The helmet of claim 11, wherein the communication module includes a global positioning system and is further configured to provide a location signal to locate the user.

17. A helmet comprising:
a shell configured to be worn on a head of a user;
a sensor coupled to the shell, the sensor being configured to detect an event affecting the shell and to generate a signal;
a control module coupled to the shell and the sensor, the control module including a notification device configured to generate an audible signal to the user when the sensor detects an event; and
a communication module coupled to the shell and the control module, the communication module being configured to receive the signal from the control module when the sensor detects an event.

18. The helmet of claim 17, wherein the control module further comprises a switching device, the switching device being configured to deactivate the communication module when manipulated by the user.

19. The helmet of claim 17, wherein the communication module is further configured to generate a signal to a rescue assistance center after a predetermined time period.

20. The helmet of claim 17, further comprising a power supply coupled to shell and the control module, the power supply being configured to supply power to the control module.

21. A method of detecting an event and transmitting a signal upon detecting the event, the method comprises:
donning a helmet on a head of a user;
wearing the helmet during an activity involving movement at a rate of speed;
detecting a deceleration of the helmet below a predetermined threshold rate of deceleration;
generating a signal upon detecting the deceleration after a predetermined time period; and
providing a response to the signal.

22. The method of claim 21, wherein donning the helmet includes fastening at least one strap portion under a chin of the user to activate components of a system capable of detecting the deceleration and generating the signal.

23. The method of claim 21, further comprising detecting inactivity of the helmet for a predetermined period of time and generating a signal upon detecting the inactivity.

24. The method of claim 21, further comprising generating an audible signal to the user when detecting the deceleration of the shell.

25. The method of claim 24, further comprising activating a switch to cease the generation of the signal.

26. The method of claim 21, wherein providing a response includes locating a position of the user.

27. A method of detecting an event and transmitting a signal upon detecting the event, the method comprises:
donning a helmet on a head of a user by fastening at least one strap portion under a chin of the user to activate components of a system capable of detecting an event;
wearing the helmet during an activity involving movement at a rate of speed;
detecting an event;
generating a signal upon detecting the event; and
providing a response to the signal.

28. A method of detecting an event and transmitting a signal upon detecting the event, the method comprises:
donning a helmet on a head of a user to activate components of a system capable of detecting an event;
wearing the helmet during an activity involving movement at a rate of speed;
detecting an event and generating an audible signal to notify the user of the event;
generating a signal upon detecting the event if the user does not respond in a predetermined manner; and
providing a response to the signal.
